(19) United States
(12) Patent Application Publication
(10) Pub. No.: US 2025/0304136 A1
(43) Pub. Date: Oct. 2, 2025

(54) EQUIPMENT TRANSPORTATION DEVICE COMPRISING SWING UNDER WHEEL MECHANISM

(71) Applicants: David Anthony Cayton, Bahama, NC (US); Israel Hernandez Parra, Wake Forest, NC (US)

(72) Inventors: David Anthony Cayton, Bahama, NC (US); Israel Hernandez Parra, Wake Forest, NC (US)

(21) Appl. No.: 19/092,810

(22) Filed: Mar. 27, 2025

Related U.S. Application Data
(60) Provisional application No. 63/571,530, filed on Mar. 29, 2024.

(51) Int. Cl. B62B 5/00

(52) U.S. Cl. CPC B62B 5/0083

(57) ABSTRACT

The invention is an improved device that can be used to easily and effectively transport a wide variety of items from a first location to a second location. One embodiment of the transportation device includes at least one latch that allows the device to releasably attach to an item to be transported. The device also includes a frame and a swing under wheel. Advantageously, the transport device can be used to transport a variety of heavy or bulky equipment from a first location to a second location.

### FIELD OF THE INVENTION

The presently disclosed subject matter relates to a device that can be used to quickly and easily transport a variety of equipment items from a first location to a second location across various terrains. Advantageously, the disclosed device includes a swing under wheel mechanism that can be easily engaged and disengaged to enable movement of various items, such as (but not limited to) concrete trowel machines, warehouse pallets, toolboxes, and the like.

### BACKGROUND

Transporting heavy construction and industrial equipment traditionally requires multiple individuals, forklifts, and/or specialized carts. Thus, conventional solutions are bulky, expensive, difficult to use or maneuver, and/or are limited to a single use application. Specifically, manual lifting and carrying heavy items can easily cause injury to workers. Manual lifting is also time consuming, leading to delays in transporting items. Conventional devices for use in transporting bulky items typically include wheel attachments that do not function well on uneven terrains, such as mud, gravel, and sand. Further, existing transport systems are not adaptable for different machine designs and instead require permanent modifications to the equipment being transported. It would therefore be beneficial to provide a universal transportation device that includes a swing under wheel mechanism that can be used for quickly and easily transporting one or more items over a variety of terrains.

### SUMMARY OF THE INVENTION

In some embodiments, the presently disclosed subject matter is directed to a transport device. Particularly, the device comprises at least one latch defined by an upper L-shaped arm comprising a first end and an opposed second end, wherein the upper arm second end includes an indentation. The term “indentation” refers to any type of groove, opening, concave feature, and/or recessed area. The latch also includes a lower planar (e.g., with a generally flat and/or straight shape) arm with a first end and an opposed second end, wherein the lower arm second end includes an upward extending fin. The upper and lower arms are configured in a first orientation wherein the fin and the indentation are overlayed (e.g., fully or partially overlapping) and a second orientation wherein the fin and the indentation are not overlayed (e.g., separated). The lower arm is configured to pivot relative to the upper arm. The term “pivot” refers to an intentional, designed, and/or controlled movement of an element about a point or axis. The device includes at least one wheel comprising an axle. The device includes a frame with a first end and an opposed second end and a pair of legs, wherein the frame first end is attached to the at least one latch and wherein the frame second end includes a wheel yoke that houses a portion of the wheel. The wheel comprises a first orientation positioned horizontally relative to the frame and a second orientation wherein the wheel is positioned below a plane of the frame.

In some embodiments, the wheel yoke includes a rest positioned on a lower surface of the yoke in the first orientation of the wheel and is positioned on an upper surface of the yoke in the second orientation of the wheel.

In some embodiments, the at least one latch is a spring loaded latch.

In some embodiments, the device further comprises a stabilizer bar positioned between two adjacent latches.

In some embodiments, the upper and lower arm first orientation is an at rest orientation and the upper and lower arm second orientation is achieved via pulling of a frame release to separate the upper and lower arms.

In some embodiments, the length and width of the frame legs are adjustable.

In some embodiments, in the upper and lower arms first orientation, the upper arm indentation and the lower arm fin are overlayed to create an enclosed shape (e.g., circular or oval).

In some embodiments, the upper arm has a length of about 10-20 inches, a width of about 0.5-5 inches, and a height of about 2-6 inches.

In some embodiments, the lower arm has a length of about 2-10 inches, a width of about 0.1-3 inches, and a height of about 1-5 inches.

In some embodiments, the wheel has a length, a width, and a thickness of about 5-15 inches.

In some embodiments, the presently disclosed subject matter is directed to a method of transporting an item from a first location to a second location. Particularly, the method comprises positioning the disclosed transport device with the wheel in the first orientation. The method includes maneuvering the latch to the second orientation and positioning a bar at a first end of the item to be transported within the upper arm indentation. The method includes maneuvering the latch to the first orientation such that the bar is secured within the opening created by the indentation and the overlayed fin. The method includes lowering a handle of the item attached at a second end of the item in a downward direction to lift the second end of the item, whereby the wheel automatically swings below a bottom face of the item to be transported to the second orientation and the weight of the item to be transported is in direct contact with the rest. The method includes raising the item handle such that a weight of the item to be transported is supported by the wheel. The method includes transporting the item from the first location to the second location.

In some embodiments, the item is a concrete trowel machine.

In some embodiments, the item is centered above the wheel when the wheel is in the second orientation.

In some embodiments, the method includes detaching the at least one latch from the item to be transported by lowering the equipment handle to thereby raise the first end of the item, thereby rotating the wheel to the first orientation. The method also includes applying pressure to the latch to transition the upper and lower arms to the second orientation and removing the item bar from the interior of the at least one latch.

In some embodiments, the bar has a circular or round cross sectional shape.

In some embodiments, the bar has a circular or cross-sectional shape that is the same as the shape of the latch opening in the first orientation of the upper and lower arms.

### BRIEF DESCRIPTION OF THE DRAWINGS

FIG. 1a is a perspective view of a transportation device in accordance with some embodiments of the presently disclosed subject matter.

FIG. 1b is a side plan view of the transportation device of FIG. 1a in accordance with some embodiments of the presently disclosed subject matter.

FIG. 2a is a side plan view of a device latch upper arm in accordance with some embodiments of the presently disclosed subject matter.

FIG. 2b is a top view of a device latch upper arm in accordance with some embodiments of the presently disclosed subject matter.

FIG. 2c is a front view of a device latch upper arm in accordance with some embodiments of the presently disclosed subject matter.

FIG. 3a is a side plan view of a device latch lower arm in accordance with some embodiments of the presently disclosed subject matter.

FIG. 3b is a top view of a device latch lower arm in accordance with some embodiments of the presently disclosed subject matter.

FIG. 3c is a front view of a device latch lower arm in accordance with some embodiments of the presently disclosed subject matter.

FIG. 4a is a perspective view of a pair of device latches in accordance with some embodiments of the presently disclosed subject matter.

FIG. 4b is a side plan view of a pair of device latches in accordance in an at rest orientation with some embodiments of the presently disclosed subject matter.

FIG. 4c is a side plan view of a pair of device latches in an extended orientation in accordance with some embodiments of the presently disclosed subject matter.

FIG. 4d is a side plan view of the device latches of FIG. 4c is a non-extended orientation in accordance with some embodiments of the presently disclosed subject matter.

FIG. 5a is a side plan view of a device wheel attached to a frame in accordance with some embodiments of the presently disclosed subject matter.

FIG. 5b is a side plan view of a device wheel in accordance with some embodiments of the presently disclosed subject matter.

FIG. 5c is a front view of a device wheel in accordance with some embodiments of the presently disclosed subject matter.

FIG. 5d is a perspective view of a device wheel and associated frame in accordance with some embodiments of the presently disclosed subject matter.

FIG. 6 is a perspective view of a device in accordance with some embodiments of the presently disclosed subject matter.

FIGS. 7a-7f illustrate one method of using the device with an item of equipment in accordance with some embodiments of the presently disclosed subject matter.

FIGS. 8a-8e illustrate one method of detaching the device from an item of equipment in accordance with some embodiments of the presently disclosed subject matter.

### DETAILED DESCRIPTION OF THE INVENTION

For the purpose of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “an element” means at least one element and can include more than one element. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods. Thus, the term “about” is used to provide flexibility to a numerical range endpoint by providing that a given value may be “slightly above” or “slightly below” the endpoint without affecting the desired result.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

All methods described herein can be performed in any suitable order unless otherwise indicated herein or otherwise clearly contradicted by context. The use of any and all examples, or exemplary language (e.g., “such as”) provided herein, is intended merely to better illuminate the invention, and does not pose a limitation on the scope of the invention unless otherwise claimed. No language in the specification should be construed as indicating any unclaimed element as essential to the practice of the invention.

Unless otherwise defined, all technical terms used herein have the same meaning as commonly understood by one of ordinary skill in the art to which this disclosure belongs.

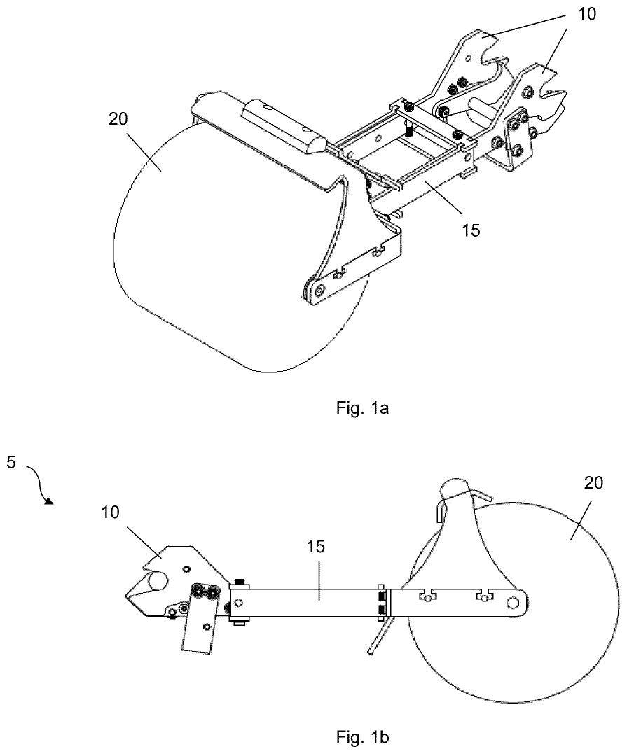

The presently disclosed subject matter is directed to an improved device that can be used to easily and effectively transport a wide variety of items from a first location to a second location. One embodiment of transportation device 5 is illustrated in FIGS. 1a and 1b. In some embodiments, device 5 can be a dolly. The term “dolly” refers to any type of wheeled device that can support at least a portion of a pallet or other item of equipment so that it can be moved. As shown, the disclosed device includes at least one latch 10 that allows the device to releasably attach to an equipment item to be transported. The device also includes swing under wheel 20 and frame 15 that connects the wheel and the latches. As described in detail below, transport device 5 can be used to transport a variety of heavy or bulky equipment from a first location to a second location.

As noted above, device 5 includes one or more latches 10 that can attach to the equipment being transported. The term “latch” refers to any mechanical connector that releasably attaches a first element to a second element (e.g., device 5 to a concrete trowel). In some embodiments, latch 10 can include L-shaped upper arm 25 and planar lower arm 30 that are overlayed and configured such that the lower arm moves relative to the upper arm. In this way, the lower arm can easily grip and attach to any of a wide variety of equipment items to be moved.

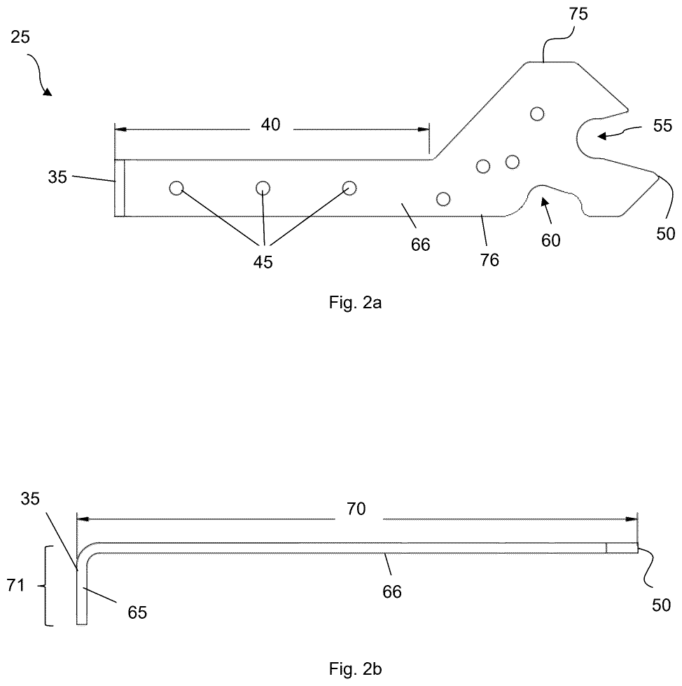

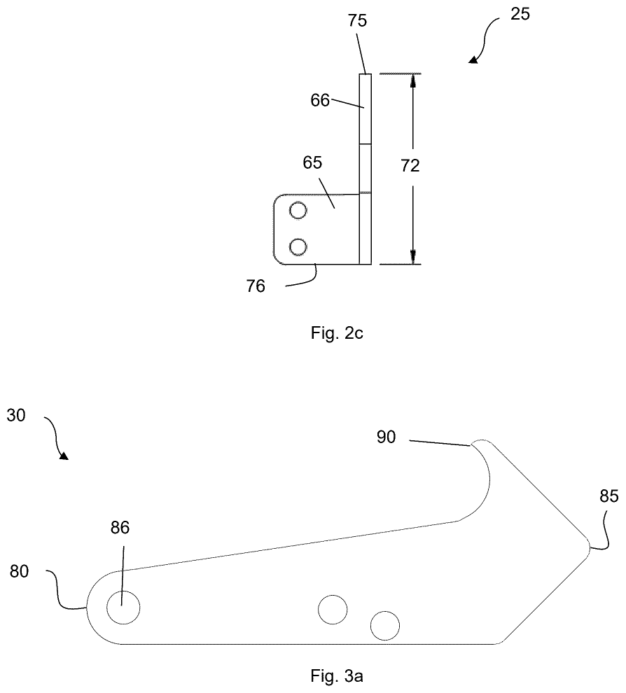

One embodiment of upper arm 25 is illustrated in FIGS. 2a-2c. As shown, the upper arm includes first end 35 that includes planar body 40 that attaches to the device frame 15. The body can include a plurality of apertures 45 that allow the length of the frame and/or distance between the latches and the frame to be lengthened or shortened as needed for proper connection to an equipment item. Body 40 can have any suitable length, such as about 7-8 inches (e.g., at least/no more than about 5, 6, 7, 8, 9, 10, 11, or 12 inches).

Upper arm 25 also includes second end 50 with indentation 55 that cooperates with the lower arm to create a hinged jaw that can easily attach to an equipment item. The upper arm also includes lower opening 60 that is configured for insertion of a stabilizer bar that attaches a pair of upper and lower arms together to a corresponding frame. Second end 50 also includes a plurality of connection apertures that allow for attachment of the lower jaw. As shown in FIG. 2b, the upper arm can have an L-shape defined by short member 65 that attaches to the frame for stability. The upper arm also includes long member 66 includes the latch elements.

Upper arm 25 can have length 70 of about 13-14 inches in some embodiments (e.g., at least/no more than about 10, 11, 12, 13, 14, 15, 16, 17, 18, 19, or 20 inches). The term “length” refers to the longest straight line distance between first and second ends 35 and 50. The upper arm can also include width 71 of about 2 inches (e.g., at least/no more than about 0.5, 1, 1.5, 2, 2.5, 3, 3.5, 4, 4.5, or 5 inches). The term “width” refers to the longest straight line distance perpendicular to the length.

The upper arm includes height 72 of about 4 inches (e.g., at least/no more than about 2, 3, 4, 5, or 6 inches). The term “height” refers to the longest distance between the top 75 and bottom 76 of the upper arm.

It should be appreciated that the ranges given throughout for length, width, and height (or any other ranges) throughout the specification are representative examples only and are not limiting.

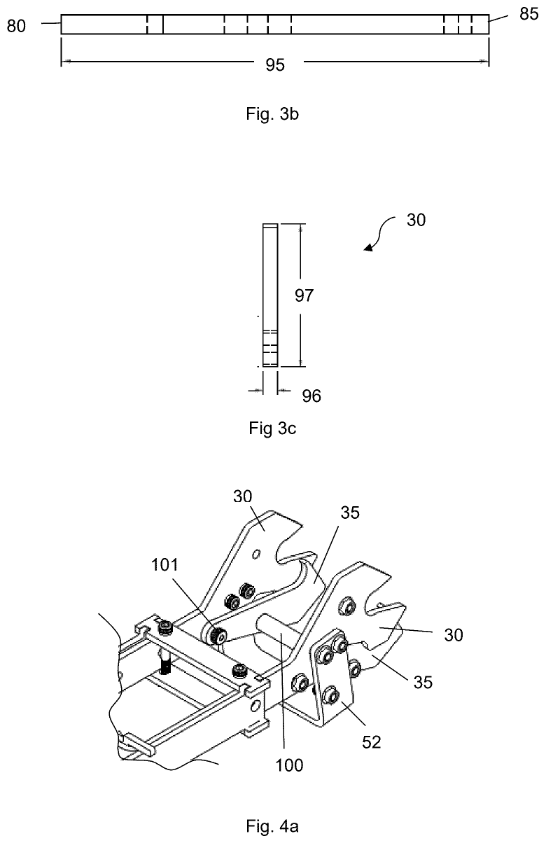

As noted above, the latch also includes lower arm 30 that cooperates with the upper arm. One embodiment of the device lower arm is illustrated in FIGS. 3a-3c. As shown, the lower arm includes first end 80 and opposed second end 85. The first end includes pivot point aperture 86 that allows for connection with the upper arm using any mechanical elements (e.g., screws, bolts, magnets, clips, fasteners, and the like). In this way, the lower arm can move relative to the upper arm that remains stationary.

Second end 85 of the lower arm includes upward extending and tapering fin 90 that is overlayed with indentation 55 of the upper arm when the hinge is assembled. The fin and the indentation cooperate to create a clamping and unclamping feature to the latch, allowing the device to attach and detach from an item of machinery. Further, when overlayed, fin 90 and indentation 55 of the upper and lower arms create a shape (e.g., circle) that is used to grip an associated piece of equipment.

Lower arm 30 can include length 95 of about 5 inches in some embodiments (e.g., at least/no more than about 2, 3, 4, 5, 6, 7, 8, 9, or 10 inches). The lower arm can also include width 96 of about 0.25 inches (e.g., at least/no more than about 0.1, 0.25, 0.5, 0.75, 1, 1.25, 1.5, 1.75, 2, 2.25, 2.5, 2.75, or 3 inches). The lower arm can further include height 97 of about 2.5 inches (e.g., at least/no more than about 1, 1.5, 2, 2.5, 3, 3.5, 4, 4.5, or 5 inches).

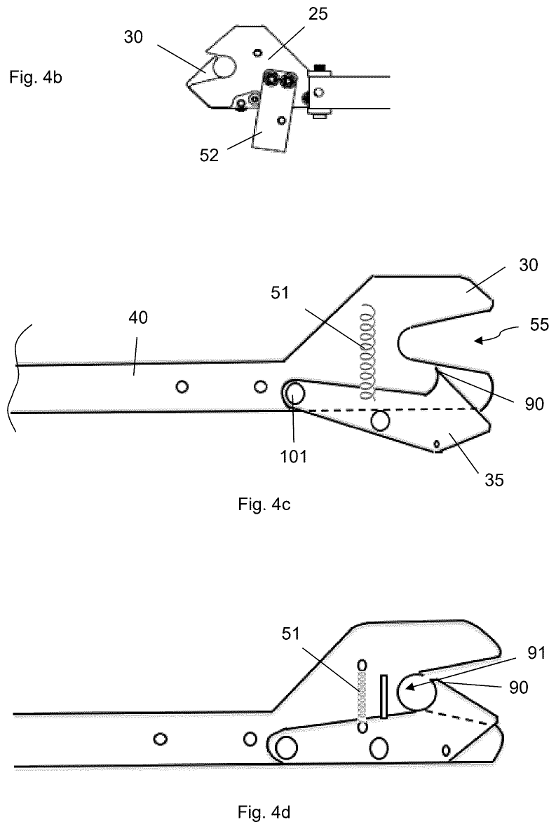

As shown in FIGS. 4a and 4b, each pair of upper and lower arms are overlayed and attached together using frame stabilizer bar 100. The stabilizer bar can be any element that secures the upper and lower arms together to provide structural rigidity and maintain alignment of the arms and the latches under load. Each latch includes the lower arm attached to an inner surface of the upper arm (e.g., the lower arms are facing each other) when the latches are attached to frame 15.

In some embodiments, latch 10 can be spring loaded. The term “spring loaded” refers to an arrangement that utilizes a spring for connecting, securing, or attaching one or more objects to another object (e.g., the upper and lower arms). Examples of a spring element include a compression spring, a leaf spring, a coil spring, or an elastic band. The term “spring-loaded” thus refers to a device having at least one element that can be biased or urged into at least one position by a spring. For example, the upper and lower arms can be attached via pivot 101 that allows the lower jaw to move relative to the upper jaw (e.g., the fin aligns with the upper arm indentation 55) via spring 51. For example, release 52 can be manually extended in a downward direction to separate the lower arm from the upper arm. The release can take any form, such as a handle or movement bar.

FIG. 4c illustrates one embodiment where spring 51 is extended after a user has maneuvered release 52 in a downward direction, pulling the lower jaw from the upper jaw. In this way, a piece of equipment can be inserted into the exposed indentation 55. Once pressure from the spring is released (e.g., pressure is no longer applied to release 52), the lower and upper jaws are aligned together and overlayed to maintain a grip on an item of equipment, as shown in FIG. 4d. Thus, in the at rest configuration, the lower arm is biased towards the upper arm such that fin 90 is positioned within upper jaw opening 50 and is held in place via spring 51.

In this way, the combination of the latch lower and upper arms join together and can attach and hold an item to be moved within area 91. For example, one or more latches 15 can attach to the item's frame by positioning the frame within area 91 using the disclosed spring loaded and quick release latch. Once the spring is released and the upper and lower jaws are again biased together, the item frame is held within area 91 and the item to be moved can be then relocated as described below. As used herein, the term “quick release” refers to the ability to detach one component from another component without the use of tools. Thus, the upper and lower arms of the latch can be easily separated or attached to repeatably connect and disconnect device 5 to an item of equipment.

In some embodiments, when the lower and upper arms of the latch are advanced together, they form a circular, round or oval shape within area 91 that can be used to directly attach device 5 to an item of equipment to be moved. For example, concrete trowel machines include a round bar frame that can be used for attachment of the latches. Stated another way, the round bar frame of a concrete trowel machine can be gripped by upper and lower arms 25, 30 and held within area 91. Concrete trowel machines are well known in the art (e.g., U.S. Patent/Publication Nos. 7,771,139; 2024/0200343; and 2025/0052077, all incorporated herein by reference). However, the presently disclosed subject matter is not limited.

The latches can be configured to clamp onto a bar (e.g., round bar) on the equipment to be moved. Each latch can lock automatically when pushed onto the bar which automatically extends spring 51 that separates the upper and lower arms. Each latch can disengage by pulling up on release 52.

For items with a flat bar frame, the presently disclosed subject matter can include a wedge-lock adapter that converts the machine non-round bar into a round bar to ensure capability within area 91 of the latch. Thus, on equipment flat bar frames, a wedge lock adaptor can be attached to create a circular or round section of the bar frame. The circular or round section is then attached to device 5 using latch 10.

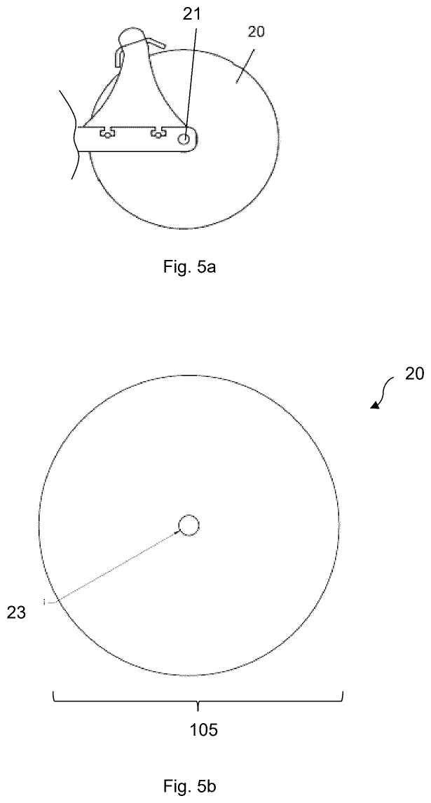

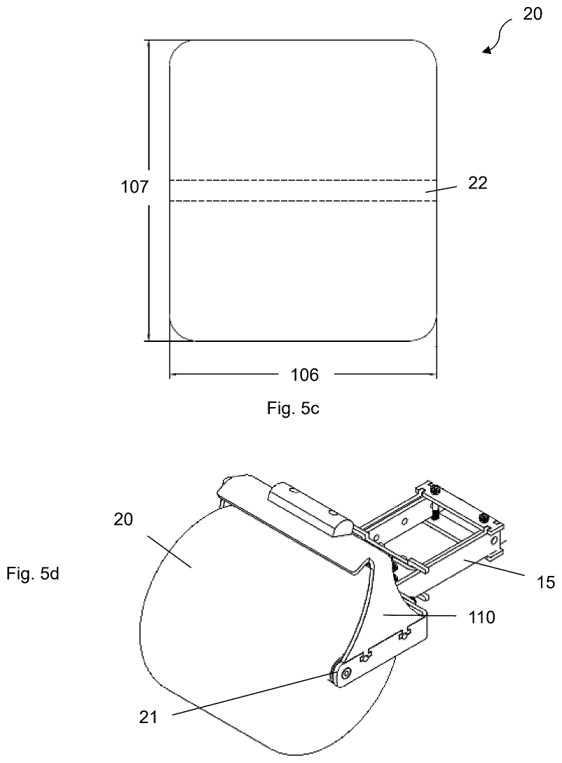

Transportation device 5 also includes swing under wheel 20 that includes a first orientation in an approximately horizontal configuration relative to the frame, and a second orientation where the wheel is positioned below the plane of the frame. FIGS. 5a and 5b illustrate one embodiment of wheel 20. The term “wheel” refers to any device that allows locomotion and that rolls on a surface. In some embodiments, the disclosed wheel can rotate about a central axle 21 provided by the frame. As shown in FIG. 5b, the wheel can include central passageway 22 that spans the center of wheel and provides an access through which the axle can pass during use. Passageway 22 can have diameter of about 0.75 inches in some embodiments (e.g., at least/no more than about 0.25, 0.5, 0.75, 1, 1.25, 1.5, 1.75, or 2 inches).

In some embodiments, the wheel can include length 105, width 106, or height 107 of about 10 inches (e.g., at least/no more than about 5, 6, 7, 8, 9, 10, 11, 12, 13, 14, or 15 inches), as shown in FIG. 5c. The wheel can be configured as a wide, inflatable rubber tire, allowing it to move smoothly over rough or uneven terrain.

It should be appreciated that the wheel is not limited and can be interchangeable, allowing for different when types to be added based on terrain needs.

Although a single wheel is shown, the presently disclosed subject matter also includes embodiments that comprise two or more wheels.

As shown in FIG. 5d, wheel 20 can be mounted at one end of the device in a first orientation. The wheel can be mounted within wheel yoke 110 of the frame. The wheel yoke can be used to protect, control, and/or guide movement of the wheel. The wheel is mounted on a solid axle, which is secured to the lower arms of frame 15. The axle is held in place using standard hardware such as cotter pins or lock nuts (or any suitable attachment elements known in the art). The axle and wheel are used to support the weight of the equipment to be moved, as noted below.

The wheel yoke includes rest 111 that is positioned adjacent to the equipment item to be moved during transportation. The rest can be constructed from any suitable material, such as rubber, plastic, and the like and ensures that the equipment is not damaged during movement.

As noted above, frame 15 is configured between wheel 20 and latches 10. As noted above, the frame includes wheel yoke 110 that supports wheel 20 and acts as a pivoting swing arm during use. The wheel yoke can be configured to fit over a portion of the wheel in some embodiments.

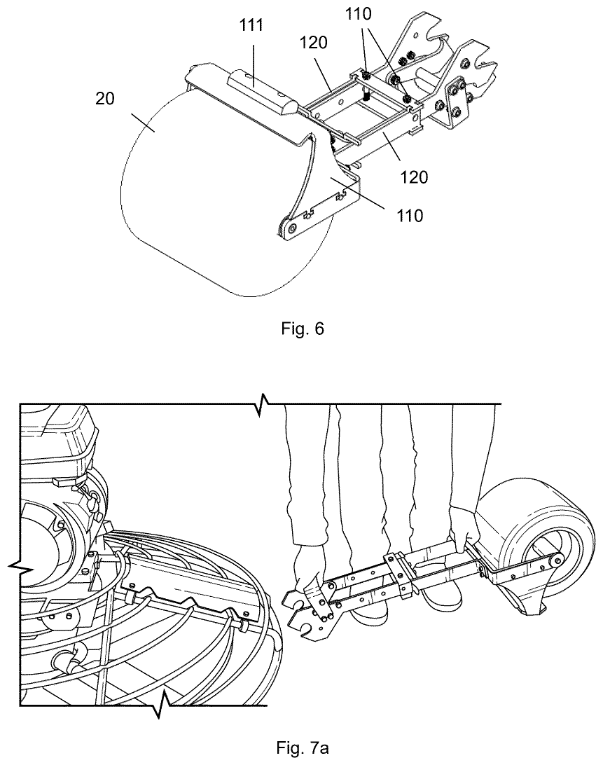

The frame also includes legs 120 of adjustable length, allowing for use with a variety of equipment items of various sizes. For example, legs 120 can be adjustable in length using spring-loaded pin holes, although any mechanism can be used. Thus, the frame can be telescoping to fit various sizes of concrete trowel machines (e.g., standard 36 inch, 42 inch, and 48 inch models in some embodiments). As shown in FIG. 6, a user can adjust the frame legs to the proper width and a spring loaded pin 125 automatically locks the frame in place, ensuring that wheel 20 swings into proper alignment with the center of the item to be transported.

Planar region 40 of each latch upper arm attaches to the frame legs using any conventional mechanism, such as the use of screws, fasteners, and the like. In some embodiments, the length of each upper arm can be adjusted along the length of each frame leg through aligned apertures in each component that are attached and detached as needed to lengthen an associated latch arm.

The latch includes a small release 52 that the user pulls upward to disengage the dolly from the equipment's round bar. The latch engages automatically when the dolly is pressed onto the bar, requiring no manual tightening or tools.

Frame 15 and latches 10 can be constructed from any suitable rigid material, such as (but not limited to) steel, stainless steel, copper, aluminum, reinforced plastic, composite materials, or combinations thereof.

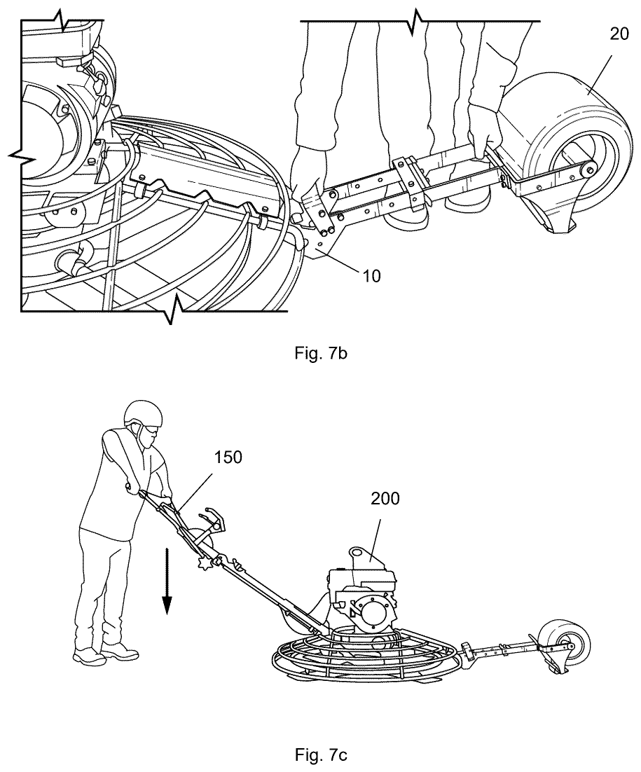

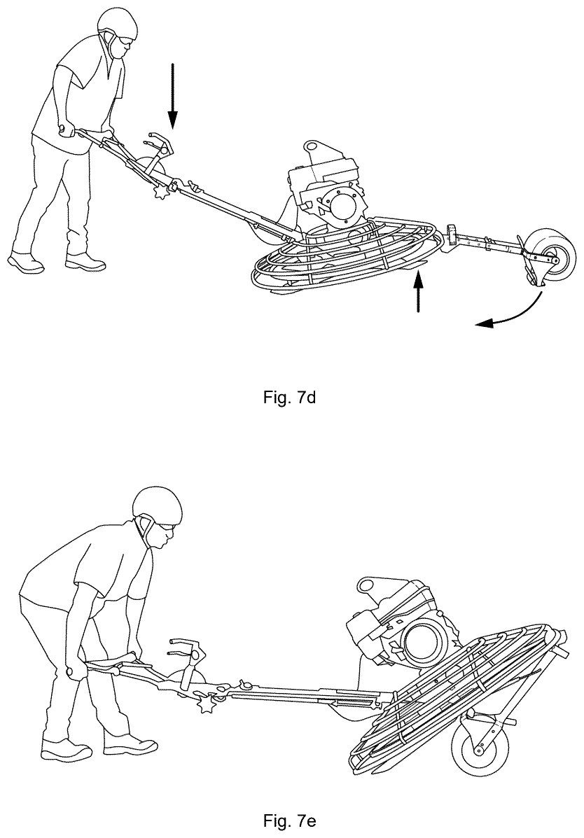

In use, device 5 attaches to item 200 to be transported by advancing spring-loaded latch 10, as shown in FIGS. 7a and 7b. Specifically, the latch upper and lower arms are separated by applying pressure to open the arms (separate the fin from indentation 55). A portion of the advanced together, attaching to the item's frame. As noted above, the arms of latch 10 can be advanced together to grip and/or fit around a round bar frame. Alternatively, a wedge-lock adapter can be used to convert an item flat bar frame to a round bar to ensure that the latches can attach to item 200. In this way, device 5 can be attached to item 200, which can be a concrete trowel machine or any other compatible equipment. As noted above, device 5 is also compatible with adapter brackets that are used with equipment that does not have a round bar (e.g., flat bar skirt trowel machines) to create a compatible connection point.

A user then pushes down on handle 150 of item 200 to lift the front of the item as shown in FIG. 7c. As a result, the equipment center of gravity is shifted to allow device frame 15 to pivot naturally (e.g., through the use of gravity) around its attachment point to item 200 (e.g., latches) as shown in FIG. 7d. The downward weight of the equipment naturally stops the swing. After the wheel has been fully shifted, wheel 20 is then positioned underneath item 200, as shown in FIG. 7e. Advantageously, the wheel pivots as the latch swings around the attachment point of the equipment using the circular attachment area as described above. The wheel is thus moved beneath item 200 without any additional hardware.

Alternatively, a mechanical element can be used to position the wheel beneath item 20. For example, a gear, ratchet, or lever system can be used for controlled swing-under motion. In other embodiments, a powered pivot version can be used that comprises electric, hydraulic, or pneumatic assist to automate the swing-under mechanism.

Once centered under item 200, the user lowers the item by raising the item handle to place the associated item weight directly onto the wheel 20 as shown in FIG. 7f. No gear, ratchet, or lever is required. As shown, the wheel comes to rest in the proper position underneath the machine and stays in position due to the pressure of the load and the frame geometry. There is no physical stopper or lock needed to hold the wheel in position during use. The wheel is held in place simply by the weight of the equipment when it is lowered onto the dolly. This is sufficient to keep the wheel centered and stable while in motion. Item 200 is then fully supported for transport from a first location to a second location. In some embodiments, handle 150 can be used to pull or push the equipment in a desired direction or location, while the item is supported and rolled along wheel 20.

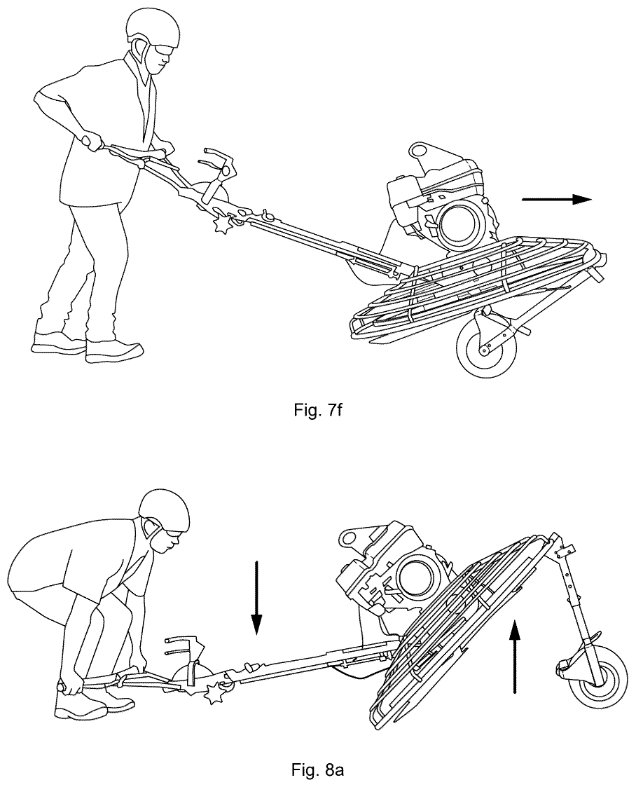

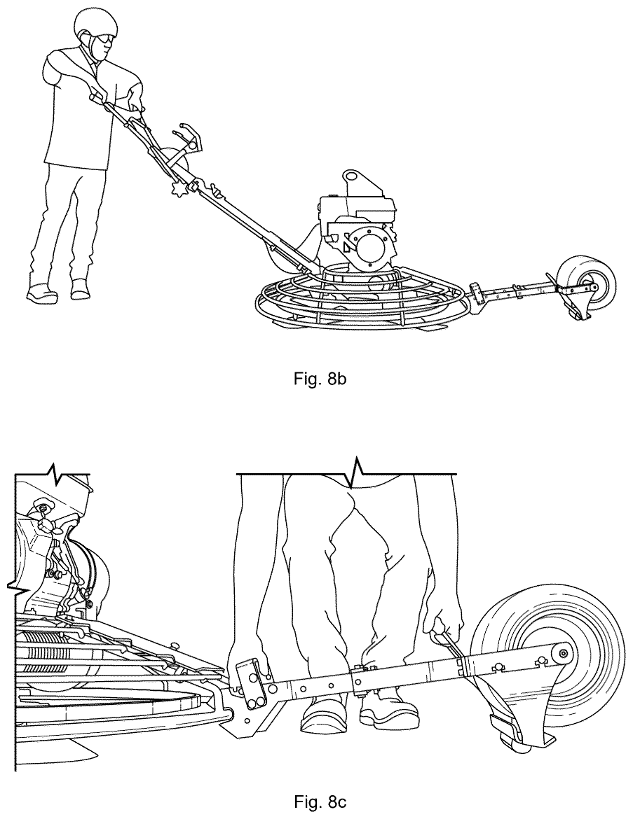

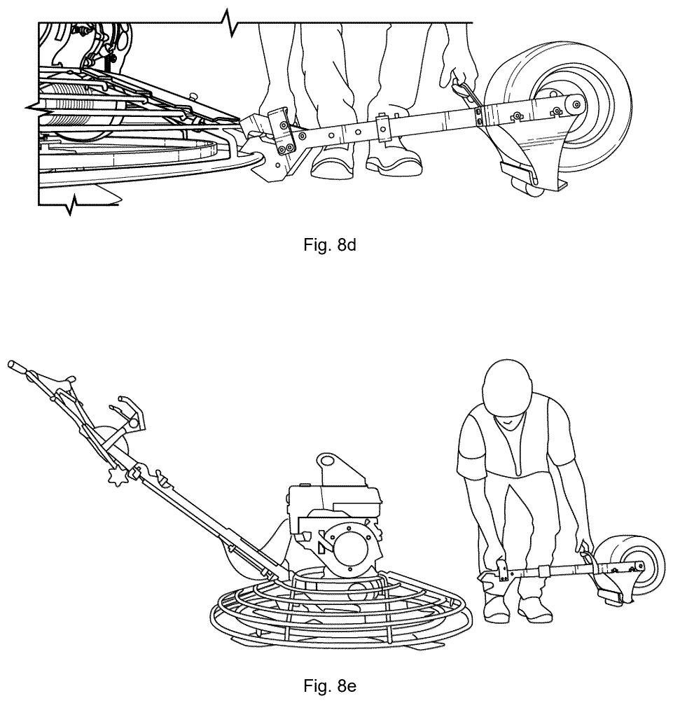

Once at a desired location, device 5 can be quickly and easily removed from item 200 by simply reversing the steps above. As shown in FIG. 8a, item handle 150 can be lowered by a user, thereby raising the attachment end of the item. As the item is raised, wheel 20 automatically pivots from underneath the item to a horizontal orientation relative to the frame, as shown in FIG. 8b. A user can then release latch 10 from item 200 by pulling release 52 to separate the upper and lower latch arms and shown in FIGS. 8c and 8d. Device 5 is then detached from item 200 and can be reused at any desired time on any suitable piece of equipment.

The presently disclosed transportation device includes many advantages over prior art devices. For example, device 5 can be used to transport a variety of items 200 from a first location to a second location. For instance, warehouse pallets can be pre-manufactured with a built in round bar attachment suitable for use with the disclosed device.

Once attached to item 200, device 5 can allow for movement over a variety of surfaces, including uneven surfaces (e.g., gravel, grass, sand, dirt, mud) and rough warehouse floors and concrete.

Advantageously, device 5 can be used to transport multiple items, saving time. For example, the device can be used with multiple pallets.

Device 5 can include an interchangeable wheel, allowing for customization depending on the type of terrain. For example, the wheels can include inflatable rubber, solid rubber, composite, plastic, and/or all terrain wheels.

The disclosed device can be used to transport a wide variety of items, such as concrete trowel machines, warehouse logistics and pallet transport items, lawn and garden equipment, medical and hospital carts, military and emergency response transport, industrial and heavy duty factory logistics, consumer items (such as coolers, toolboxes, recreational transport), and the like.

Although discussed above in reference to use with a concrete towel or other similar machinery, the presently disclosed subject matter can be used with a variety of items. For example, device 5 can be used with a flat platform (similar to a pallet) with a foldable handle and a round bar mounted at the front. The round bar allows the item to connect using the same latch and swing-under mechanism. The user can load the deck with items (e.g., a generator or bags of concrete), tilt the handle, swing the wheel under, and then push the loaded deck across a job site.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A transport device comprising:
at least one latch defined by:
an upper L-shaped arm comprising a first end and an opposed second end, wherein the upper arm second end includes an indentation;
a lower planar arm with a first end and an opposed second end, wherein the lower arm second end includes an upward extending fin, wherein the upper and lower arms are configured in a first orientation wherein the fin and the indentation are overlayed and a second orientation wherein the fin and the indentation are not overlayed, and wherein the lower arm is configured to pivot relative to the upper arm;
at least one wheel comprising an axle;
a frame with a first end and an opposed second end and a pair of legs, wherein the frame first end is attached to the at least one latch and wherein the frame second end includes a wheel yoke that houses a portion of the wheel and the wheel yoke includes a rest;
wherein the wheel comprises a first orientation positioned horizontally relative to the frame and a second orientation wherein the wheel is positioned below a plane of the frame.

2. The transport device of claim 1, wherein the wheel yoke rest is positioned on a lower surface of the yoke in the first orientation of the wheel and is positioned on an upper surface of the yoke in the second orientation of the wheel.

3. The transport device of claim 1, wherein the at least one latches are spring loaded latches.

4. The transport device of claim 1, further comprising a stabilizer bar positioned between two adjacent latches.

5. The transport device of claim 1, wherein the upper and lower arm first orientation is an at rest orientation and the upper and lower arm second orientation is achieved via pulling of a frame release to separate the upper and lower arms.

6. The transport device of claim 1, wherein the length and width of the frame legs are adjustable.

7. The transport device of claim 1, wherein in the upper and lower arms first orientation the upper arm indentation and the lower arm fin are overlayed to create an enclosed shape.

8. The transport device of claim 7, wherein the shape is circular or oval.

9. The transport device of claim 1, wherein the upper arm has a length of about 10-20 inches, a width of about 0.5-5 inches, and a height of about 2-6 inches.

10. The transport device of claim 1, wherein the lower arm has a length of about 2-10 inches, a width of about 0.1-3 inches, and a height of about 1-5 inches.

11. The transport device of claim 1, wherein the wheel has a length, a width, and a thickness of about 5-15 inches.

12. A method of transporting an item from a first location to a second location, the method comprising:
positioning the transport device of claim 1 with the wheel in a first orientation;
maneuvering the latch to the second orientation and positioning a bar at a first end of the item to be transported within the upper arm indentation;
maneuvering the latch to the first orientation such that the bar is secured within the opening created by the indentation and the overlayed fin;
lowering a handle of the item attached at a second end of the item in a downward direction to lift the second end of the item, whereby the wheel automatically swings below a bottom face of the item to be transported to the second orientation and the weight of the item to be transported is in direct contact with the rest;
raising the item handle such that a weight of the item to be transported is supported by the wheel;
transporting the item from the first location to the second location.

13. The method of claim 12, wherein the item is a concrete trowel machine.

14. The method of claim 12, wherein the item is centered above the wheel when the wheel is in the second orientation.

15. The method of claim 12, further comprising detaching the at least one latch from the item to be transported by:
Lowering the equipment handle to thereby raise the first end of the item, thereby rotating the wheel to the first orientation;
applying pressure to the latch to transition the upper and lower arms to the second orientation; and
removing the item bar from the interior of the at least one latch.

16. The method of claim 12, wherein the bar has a circular or round cross sectional shape.

17. The method of claim 12, wherein the bar has a circular or cross-sectional shape that is the same as the shape of the latch opening in the first orientation of the upper and lower arms.

18. The method of claim 12, wherein the upper arm has a length of about 10-20 inches, a width of about 0.5-5 inches, and a height of about 2-6 inches.

19. The method of claim 12, wherein the lower arm has a length of about 2-10 inches, a width of about 0.1-3 inches, and a height of about 1-5 inches.

20. The method of claim 12, wherein the wheel has a length, a width, and a thickness of about 5-15 inches.
